(19) United States
(12) Patent Application Publication
(10) Pub. No.: US 2015/0228393 A1
(43) Pub. Date: Aug. 13, 2015

(54) High-Voltage Transformer Apparatus with Adjustable Leakage

(71) Applicant: Stefan Waffler, Buckenhof (DE)

(72) Inventor: Stefan Waffler, Buckenhof (DE)

(21) Appl. No.: 14/619,983

(22) Filed: Feb. 11, 2015

(30) Foreign Application Priority Data
Feb. 12, 2014 (DE) 102014202531.1

(51) Int. Cl. H01F 27/24; H01F 27/32; H02M 7/537; H01F 27/28

(52) U.S. Cl. CPC H01F 27/24; H01F 27/2823; H01F 27/324; H02M 7/537

(57) ABSTRACT

A high-voltage transformer apparatus includes a transformer core, a primary winding and a secondary winding that is arranged over the primary winding. Toroidal cores are arranged spaced apart from one another and next to one another between the primary winding and the secondary winding. The toroidal cores cause leakage of magnetic flux of the primary winding.

This application claims the benefit of DE 10 2014 202 531.1, filed on Feb. 12, 2014, which is hereby incorporated by reference in its entirety.

### FIELD

The present embodiments relate to a high-voltage transformer apparatus.

### BACKGROUND

Radiofrequency high-voltage transformers for operation with inverters in which the magnetic leakage of the transformer is used as inductance or as resonant circuit component are used, for example, for generating high voltage used for the operation of an X-ray tube. For example, such inverter arrangements are of importance for X-ray imaging in medical diagnostics.

High-voltage transformers used for inverters may be configured such that the leakage of the transformer is as low as possible. This applies to flyback converters, for example. In this case, excessively high levels of leakage at the time at which the semiconductor switches are switched off would result in undesired overvoltages.

In the case of other circuit concepts (e.g., in the case of a series resonant converter including a transformer), in which a series resonant circuit is formed in series with the transformer, the leakage inductance may be used in a targeted manner as series inductor of the resonant circuit. Via a corresponding design of the transformer, the leakage inductance may be adjusted so that the leakage inductance is equal to the inductance required for the series resonant circuit.

One possibility of adjusting the leakage inductance includes changing the numbers of turns of the windings of the transformer. The leakage inductance is proportional to the square of the number of turns.

A further possibility includes adapting the geometric conditions in the transformer. For example, the leakage inductance of a transformer in which primary and secondary winding are realized in two winding stacks arranged one above the other may be increased by virtue of a greater spacing being selected between the winding stacks. This reduces the magnetic coupling between the primary and secondary windings. The flux in the primary winding is no longer completely magnetically coupled to the secondary winding. Some of the flux is closed as leakage flux in the interspace of the winding stacks. The leakage inductance is in this case proportional to the leakage flux.

If high values for the leakage inductance are intended to be achieved, the leakage inductance may not be adjusted in the abovementioned ways. This is because the winding losses increase as the number of turns increases, or the increase in the spacing between the primary and secondary windings would result in undesired enlargement of the transformer. Therefore, an additional series inductor may be connected in series with the transformer for high inductances.

Such an inverter circuit including a high-voltage transformer with a leakage inductance is described, for example, in the laid-open specification DE 10 2011 005 446 A1.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a high-voltage transformer apparatus having a high, adjustable magnetic leakage inductance is provided.

Toroidal cores are arranged next to one another in series between a primary winding and a secondary winding of a high-voltage transformer. As a result of this, in a targeted manner, the magnetic leakage of the transformer is increased. Even very high values for the leakage, which are not achieved with a transformer design in accordance with the prior art, may be realized.

A high-voltage transformer apparatus includes a transformer core, a primary winding and a secondary winding arranged over the primary winding. Toroidal cores that are spaced apart from one another and are arranged next to one another are located between the primary winding and the secondary winding. The toroidal cores cause leakage of the magnetic flux of the primary winding.

The advantage of the apparatus according to one or more of the present embodiments in comparison with an implementation using an equivalent apparatus including a transformer of the known design and an upstream series inductor is that the series inductor is integrated magnetically in the transformer apparatus. The primary winding of the transformer performs the function of the winding of the series inductor. The transformer core also contributes to the operation of both the series inductor and the transformer.

Further to the fact that the assemblies of the transformer apparatus perform several tasks, and the number of components required may be reduced from two (e.g., series inductor and transformer) to one component (e.g., transformer with magnetically integrated series inductor), both a cost savings and a reduction of the overall installation space result.

In one development, the apparatus includes a shell-shaped transformer core, a main limb of the transformer core, on which the primary winding, the toroidal cores and the secondary winding are seated, and an outer limb of the transformer core.

In a further embodiment, the transformer core is in two parts and is not split, and the two parts each have a U-shaped formation.

In one embodiment, the toroidal cores are formed from a ferrite.

The apparatus may include a holding part that sits on the primary winding and in which the toroidal cores are arranged next to one another in series.

In a further configuration, the apparatus includes spacer holding elements that are arranged between adjacent toroidal cores and hold the toroidal cores in a position spaced apart from one another.

Due to the toroidal cores being arranged spaced apart from one another, a distributed air gap results in the leakage path, and in comparison with a concentrated air gap, the magnetic leakage field in the vicinity of the air gap may be limited in terms of spatial extent. Therefore, the amplitude of the magnetic field strength passing through the primary winding is reduced, and the radiofrequency losses that arise in the primary winding owing to this external field are reduced.

In addition, the spacer holding elements may be formed from a nonmagnetizable material.

In a further embodiment, the transformer core is formed from a ferrite.

In a further configuration, the primary winding is in the form of a multilayered foil winding.

In a further embodiment, the apparatus includes a primary coil former that is seated on the transformer core and in which the primary winding is arranged.

In a further embodiment, the secondary winding is formed from enameled copper wire.

In a further embodiment, the apparatus includes a multiple-chamber secondary coil former that is arranged on the toroidal cores and in which the secondary winding is arranged.

Due to the distribution of the secondary winding among a plurality of chambers in accordance with one or more of the present embodiments, both the parasitic winding capacitance and the layer-to-layer voltage of the layers of the winding may be kept low in the individual chambers.

In a further embodiment, the apparatus includes an insulating cover that is arranged above the secondary winding and is configured to electrically insulate the secondary winding from the transformer core.

An inverter circuit including a high-voltage transformer apparatus according to one or more of the present embodiments, and a resonant circuit including an inductance is provided. The inductance is formed by the leakage of the magnetic flux of the primary winding.

A method of use of a high-voltage transformer apparatus according to one or more of the present embodiments for forming an inductance of a resonant circuit of an inverter circuit is also provided. The inductance of the resonant circuit is adjustable via the permeability, the spacing between the toroidal cores and/or the number of toroidal cores.

### BRIEF DESCRIPTION OF THE DRAWINGS

FIG. 1 shows a longitudinal section through one embodiment of a high-voltage transformer apparatus;

FIG. 2 shows a cross section through one embodiment of a high-voltage transformer apparatus;

FIG. 3 shows a longitudinal section through one embodiment of a high-voltage transformer apparatus with an illustration of the magnetic fluxes; and

FIG. 4 shows a block circuit diagram of one embodiment of an inverter circuit including a high-voltage transformer apparatus.

### DETAILED DESCRIPTION

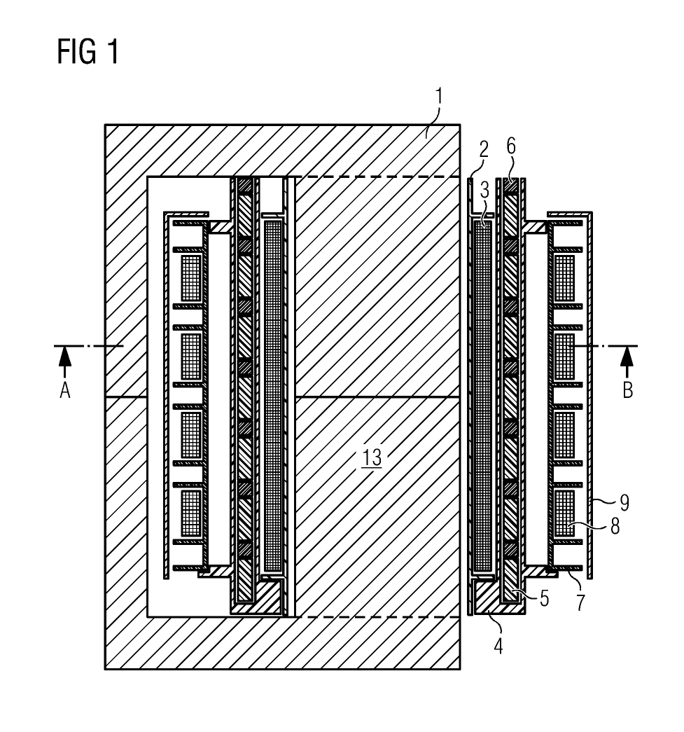

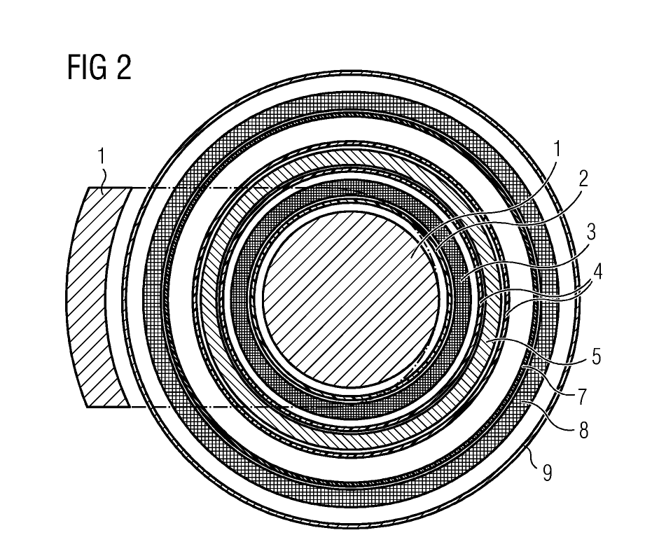

A radiofrequency high-voltage transformer with a high level of magnetic leakage may be realized by the embodiment shown in FIGS. 1 and 2. FIG. 1 shows a longitudinal section through the high-voltage transformer apparatus, and FIG. 2 shows a sectional illustration along the sectional axis A-B in FIG. 1.

A primary winding 3 and a secondary winding 8 that is distributed among a plurality of chambers are applied to a main limb 13 of a split transformer core 1, which has the shape of two assembled “U”s. The transformer core 1 may be ferrite in order to keep the magnetic core losses low.

The primary winding 3 may be in the form of a multilayered foil winding and is applied to a primary coil former 2 for mechanical fixing. The secondary winding 8 is wound with enameled copper wire distributed among the chambers of a secondary coil former 7 (e.g., among four chambers, as shown in FIG. 1). For the insulation between the secondary winding 8 and the transformer core 1, an insulating cover 9 that is arranged on the secondary winding 8 may be used.

In order to increase the magnetic leakage of the transformer apparatus, in accordance with one or more of the present embodiments, a plurality of toroidal cores 5 are provided between the primary winding 3 and the secondary winding 8. The toroidal cores 5 are arranged in series next to one another and increase the magnetic leakage of the primary winding. Owing to the number of toroidal cores 5, the magnetic cross section thereof, the permeability thereof, and via an air gap in the leakage path, the reluctance in the leakage path and therefore the magnitude of the leakage flux and thus the leakage inductance may be adjusted to a desired value.

The air gap in the leakage path may be realized as a distributed air gap via a toroidal core 5 and a nonmagnetic spacer 6 being introduced alternately into a holding part 4.

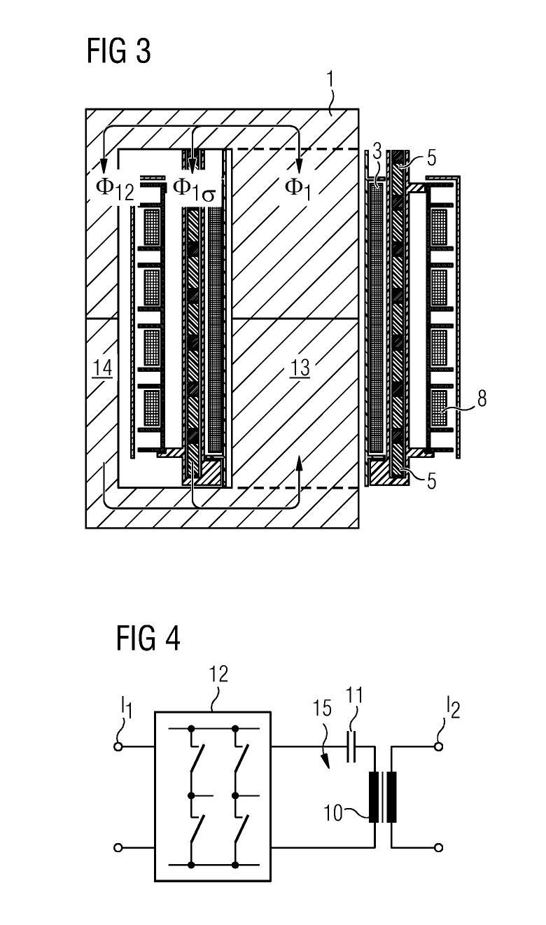

FIG. 3 shows the longitudinal section through the high-voltage transformer apparatus 1 shown in FIG. 1 with an illustration of the magnetic fluxes. The toroidal cores 5 have the effect that the magnetic flux Φ₁ in the main limb 13, which is caused by the primary winding 3, splits into a partial magnetic flux Φ₁₂ that is coupled to the secondary winding 8 and a leakage flux Φ_{1σ} that is not coupled to the secondary winding 8. The magnetic flux Φ₁ in the main limb 13 is closed via the toroidal cores 5.

Similarly to this, the induced current flow in the secondary winding 8 produces an opposing flow (not illustrated). Components of the opposing flow are superimposed by the fluxes of the primary winding 3 in the leakage path, in the main limb 13 and in the outer limb 14.

FIG. 4 shows a simplified block circuit diagram of one embodiment of a resonant circuit inverter circuit including a high-voltage transformer apparatus 10, as shown in FIGS. 1-3. A resonant circuit capacitor 11, which is connected in series with the high-voltage transformer apparatus 10 and, together with the leakage inductance of the high-voltage transformer apparatus 10, forms a series resonant circuit 15, is connected downstream of an inverter 12. The primary current I₁ flows on the primary side, and the secondary current I₂ flows on the secondary side.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A high-voltage transformer apparatus comprising:
a transformer core;
a primary winding;
a secondary winding arranged over the primary winding; and
toroidal cores that are spaced apart from one another and are arranged next to one another, the toroidal cores operable to cause leakage of magnetic flux of the primary winding, the toroidal cores being arranged between the primary winding and the secondary winding.

2. The high-voltage transformer apparatus of claim 1, wherein the transformer core is in the form of a shell,
wherein the transformer core comprises a main limb on which the primary winding, the toroidal cores and the secondary winding are seated, and
wherein the transformer core comprises an outer limb.

3. The high-voltage transformer apparatus of claim 2, wherein the transformer core is in two parts and is not split, and the two parts each have a U-shaped formation.

4. The high-voltage transformer apparatus of claim 1, wherein the toroidal cores are formed from a ferrite.

5. The high-voltage transformer apparatus of claim 1, further comprising a holding part that sits on the primary winding and in which the toroidal cores are arranged.

6. The high-voltage transformer apparatus of claim 1, further comprising spacer holding elements that are arranged between adjacent toroidal cores of the toroidal cores and hold the toroidal cores in series in a position spaced apart from one another.

7. The high-voltage transformer apparatus of claim 6, wherein the spacer holding elements are formed from a nonmagnetizable material.

8. The high-voltage transformer apparatus of claim 1, wherein the transformer core is formed from a ferrite.

9. The high-voltage transformer apparatus of claim 1, wherein the primary winding is in the form of a multilayered foil winding.

10. The high-voltage transformer apparatus of claim 1, further comprising a primary coil former that is seated on the transformer core and in which the primary winding is arranged.

11. The high-voltage transformer apparatus of claim 1, wherein the secondary winding is formed from enameled copper wire.

12. The high-voltage transformer apparatus of claim 1, further comprising a multiple-chamber secondary coil former that is arranged on the toroidal cores and in which the secondary winding is arranged.

13. The high-voltage transformer apparatus of claim 1, further comprising an insulating cover that is arranged over the secondary winding and is configured to electrically insulate the secondary winding from the transformer core.

14. An inverter circuit comprising:
a high-voltage transformer apparatus comprising:
a transformer core;
a primary winding;
a secondary winding arranged over the primary winding; and
toroidal cores that are spaced apart from one another and are arranged next to one another, the toroidal cores operable to cause leakage of magnetic flux of the primary winding, the toroidal cores being arranged between the primary winding and the secondary winding; and
a resonant circuit comprising an inductance that is formed by the leakage of the magnetic flux of the primary winding.

15. The inverter circuit of claim 14, wherein the transformer core is in the form of a shell,
wherein the transformer core comprises a main limb on which the primary winding, the toroidal cores and the secondary winding are seated, and
wherein the transformer core comprises an outer limb.

16. The inverter circuit of claim 15, wherein the transformer core is in two parts and is not split, and the two parts each have a U-shaped formation.

17. The inverter circuit of claim 14, wherein the toroidal cores are formed from a ferrite.

18. A method of use of a high-voltage transformer apparatus for forming an inductance of a resonant circuit of an inverter circuit, the high-voltage transformer apparatus comprising a transformer core, a primary winding, a secondary winding arranged over the primary winding, and toroidal cores that are spaced apart from one another and are arranged next to one another, the toroidal cores operable to cause leakage of magnetic flux of the primary winding, the toroidal cores being arranged between the primary winding and the secondary winding, the method comprising:
adjusting the inductance of the resonant circuit via permeability, the spacing between the toroidal cores, the number of the toroidal cores, or any combination thereof.
